(19) United States
(12) Patent Application Publication
(10) Pub. No.: US 2016/0201712 A1
(43) Pub. Date: Jul. 14, 2016

(54) FASTENER FOR IN SITU FLUID INJECTION

(71) Applicant: Dallas Boyd, Enterprise, AL (US)

(72) Inventor: Dallas Boyd, Enterprise, AL (US)

(21) Appl. No.: 14/954,300

(22) Filed: Nov. 30, 2015

Related U.S. Application Data
(60) Provisional application No. 62/103,461, filed on Jan. 14, 2015.

(51) Int. Cl. F16B 33/00; F16B 39/02

(52) U.S. Cl. CPC F16B 33/00; F16B 39/021

(57) ABSTRACT

A fastener having a head, a shank, and a longitudinal through hole extending through the head and the shank. When the fastener is used to fasten materials or objects together, epoxy or other fluids can be injected into the through hole and through the fastener in situ. The fastener may be used to repair voided areas under bridge expansion joints in situ by injecting epoxy through fasteners used in the expansion joint assemblies. By repairing voided areas in this manner, the roadway does not have to be disturbed to access the voided areas under the expansion joints. This repair method is faster, safer, and less expensive than currently utilized repair methods.

### CROSS REFERENCES

This application claims the benefit of U.S. Provisional Application No. 62/103,461, filed on Jan. 14, 2015, which application is incorporated herein by reference.

### FIELD OF THE INVENTION

A preferred embodiment of the present invention refers to a fastener adapted to allow a fluid to be injected through the fastener in situ.

### BACKGROUND

In the construction of concrete bridge decks, bridge expansion joints are utilized at spaced intervals along the driving surface of the bridge in order to accommodate temperature-related expansion and contraction of the construction materials, as well as movement between bridge sections. For instance, finger joints are commonly used in bridge construction for these purposes. Typically, a finger joint assembly comprises interlocking finger plates each fastened to an angle iron having anchor studs attached thereto. Each finger plate is typically fastened to the angle iron using bolts and nuts as the fastening mechanism. Bolts are placed at spaced intervals along the length of each finger plate with the head of each bolt being accessible from the surface of the roadway.

For new finger joint installations, the finger joint assemblies are completely assembled before being set in place. Once in place, concrete is then poured such that the anchor studs anchor the assembly in the concrete. As the concrete is poured, pockets of air often become trapped under the assembly against the angle iron. Once the concrete hardens, these pockets of air form voids in the concrete. When voids are formed under the joint assemblies, the voids lessen the joint's ability to withstand loads due to traffic. Over time, traffic loads may cause further deterioration of the concrete under the joint assemblies. As traffic passes over the joint assemblies, the voided areas allow for movement of the concrete under the finger plates, which may cause spalling of the concrete, thereby increasing the extent of the voids. If left unrepaired, the voided areas may cause the joint assemblies to break apart from the supporting concrete and become a potential hazard to motorists.

Currently, the recommended procedure for repairing voided areas under expansion joints is either replacement of the joint or major rehabilitation. To rehabilitate an expansion joint, concrete is chipped away to expose the voids below the joint using pneumatic hammers to break up the concrete. After the voids are exposed, workers then apply epoxy to the underside of the joint under the angle iron to fill the voided areas. This procedure is both expensive and time consuming. Repairs require lane closures and thus are often done at night to avoid long traffic delays. Repairs can be dangerous to both motorists and workers, as the repairs require workers to be present on the roadway. Once the epoxy has been applied, it must cure before lanes can be reopened to traffic.

Accordingly, there is clearly a need in the art for an improved apparatus and method for repairing voided areas under bridge expansion joints in a quick, inexpensive, safe, and effective manner.

### SUMMARY

A preferred embodiment of the invention is directed to a threaded fastener comprising a head and a shank, wherein a through hole extends longitudinally through the head and the shank. The through hole allows for the injection of fluids through the fastener in situ. In a preferred embodiment, the threaded fastener is a bolt having a hexagonal head and a threaded shank. The shank may be partially or fully threaded along its length.

The threaded fastener of the present invention is particularly advantageous in the application of fastening bridge expansion joints used in concrete bridge decks. Voids in the concrete may form below expansion joint assemblies during construction and may further deteriorate over the life of the joint due to traffic loads. Because the voids are located below the expansion joint assembly, which is anchored in the concrete, the voids are inaccessible without chipping away concrete around the expansion joints to expose the voids for repair, which is an expensive and time-consuming process. Instead of chipping concrete to remove joints or repair voided areas, the through hole in the threaded fastener allows expansion joints to be repaired in situ by injecting epoxy or any other suitable type of flowable fill material through the fastener and into the voided area. The epoxy fills the voided area, and once the epoxy cures it also functions as a strong adhesive binding the expansion joint assembly to the concrete. Because the bolt heads are accessible from the surface of the roadway, repairs can be done quickly, safely, and inexpensively without the need for chipping and re-pouring concrete.

Accordingly, one object of the present invention is to provide a fastener comprising a through hole for injecting an epoxy or other type of flowable fill material through the fastener in situ. Another object of the present invention is to provide a method for repairing voided areas under bridge expansion joints in situ in a quick, inexpensive, safe, and effective manner.

### DESCRIPTION OF THE DRAWINGS

These and other features, aspects, and advantages of the present invention will become better understood with regard to the following description, appended claims, and accompanying drawings where:

FIG. 1 depicts a sectional perspective view of a fastener embodying features of the present invention.

FIG. 2 shows a side elevational view of a fastener embodying features of the present invention.

FIG. 3 shows a cross sectional view of a bridge expansion joint installed in a concrete bridge deck using a fastener embodying features of the present invention.

FIG. 4 shows a top plan view of a bridge expansion joint installed in a concrete bridge deck using a fastener embodying features of the present invention.

FIG. 5A shows a top perspective view of an apparatus embodying features of the present invention.

FIG. 5B shows a side elevational view of an apparatus embodying features of the present invention.

FIG. 6A shows a top perspective view of a fastener embodying features of the present invention.

FIG. 6B shows a top perspective view of a fastener embodying features of the present invention.

FIG. 7A shows a side elevational view of an apparatus embodying features of the present invention.

FIG. 7B shows a side elevational view of a fastener embodying features of the present invention.

FIG. 8 shows an exemplary embodiment of an injection gun compatible with a fastener embodying features of the present invention.

FIG. 9 shows a side elevational view of a fastener embodying features of the present invention.

FIG. 10 shows a cross sectional view of a bridge expansion joint installed in a concrete bridge deck using a fastener embodying features of the present invention.

FIG. 11 shows a side elevational view of a fastener embodying features of the present invention.

FIG. 12 shows a side elevational view of a fastener embodying features of the present invention.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

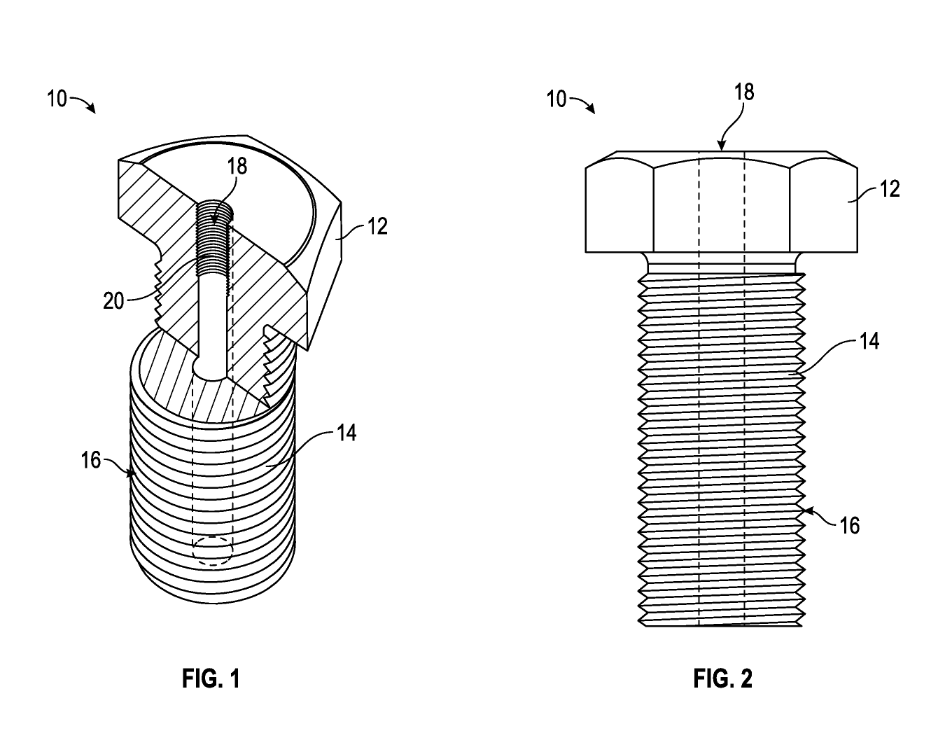

Turning now to the drawings, FIGS. 1-2 illustrate a preferred embodiment of the present invention. As illustrated in FIG. 1, the present invention comprises a fastener 10 having a through hole 18 configured such that fluids may be injected through the fastener 10 in situ. In a preferred embodiment, as illustrated in FIGS. 1-2, the fastener 10 is a bolt. In other embodiments, the fastener may be a screw, nail, or any similar type of fastener.

As shown in FIGS. 1-2, the fastener 10 comprises a head 12 and a shank 14. The shank 14 has a generally cylindrical shape and preferably has external male threads 16. The shank 14 may be partially threaded, or it may be fully threaded along its entire length. In a preferred embodiment, the head 12 has an outer surface in the shape of a polygon, and preferably in the shape of a hexagon, such that the head of the fastener can be engaged with a wrench. In alternative embodiments, the head 12 of the fastener may be configured for use with a screwdriver or any similar means for applying torque to the fastener 10 or for holding the fastener in place so that a corresponding nut 22 can be threaded onto the male threads 16 of the fastener for fastening desired materials or objects together.

As illustrated in FIGS. 1-2, the through hole 18 extends longitudinally through the head 12 and the shank 14. The through hole 18 forms an opening in the top of the head 12 at one end and an opening in the bottom of the shank 14 at the opposite end to form a continuous passageway through the fastener 10. In a preferred embodiment, the fastener 10 is configured such that the longitudinal through hole 18 extends along the axis of rotation of the fastener, though in an alternative embodiment, the through hole may be offset from the axis of rotation and still fall within the scope of the present invention.

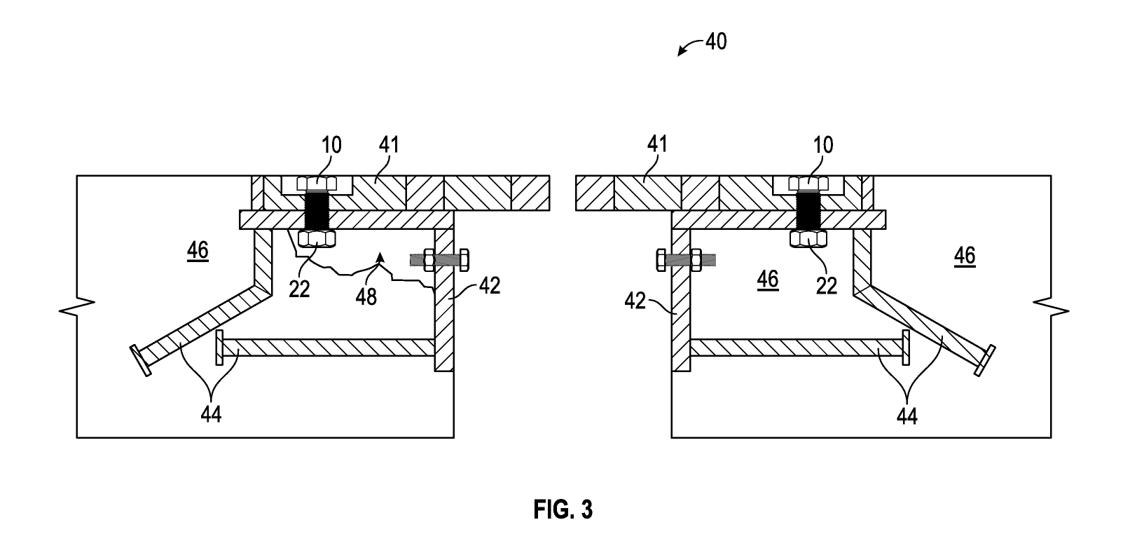

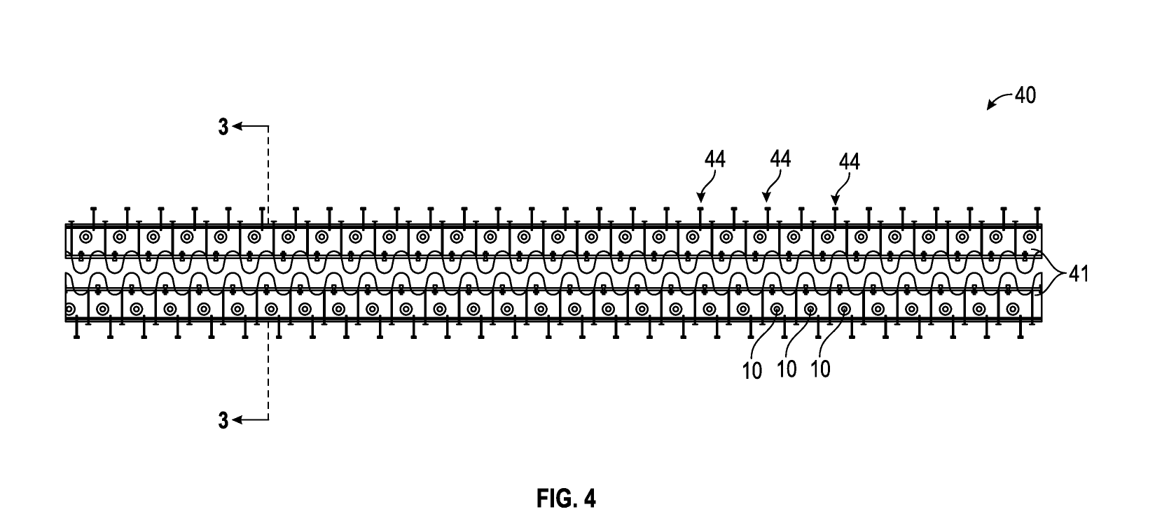

The fastener 10 of the present invention is particularly useful in the application of fastening together bridge expansion joint assemblies used in concrete bridge decks. FIGS. 3 and 4 illustrate a typical expansion joint 40 installed in a concrete bridge deck. FIG. 4 shows a top plan view of a bridge expansion joint 40 installed in a concrete bridge deck, and FIG. 3 shows a cross-sectional view of the expansion joint 40 and the concrete 46 in which the joint is anchored. A typical expansion joint 40 comprises two interlocking finger plates 41 each fastened to an angle iron 42 having a plurality of anchor studs 44 attached thereto. The anchor studs 44 anchor the assembly in the concrete 46. Each finger plate 41 is typically fastened to the angle iron 42 using bolts 10 and nuts 22 as the fastening mechanism. Bolts are placed at spaced intervals along the length of each finger plate 41 with the head of each bolt being accessible from the surface of the roadway. As shown in FIG. 3, the finger plates 41 typically have recesses in which each bolt 10 is positioned so that the heads of the bolts are flush with the surface of the roadway.

Voids tend to form in the concrete near expansion joints, particularly under the angle irons 42. FIG. 3 shows a voided area 48 in the concrete 46 under the angle iron 42 on the left side of the expansion joint 40 and non-damaged concrete 46 on the right side of the expansion joint 40. In order to repair the voided area 48, an epoxy or similar type of flowable fill material is injected into the voided area 48 via the longitudinal through hole 18 in the fastener 10. The injection is done in situ to avoid the expensive and time consuming process of chipping concrete to access the voided area. The epoxy fills the voided area 48, and once the epoxy cures it also functions as a strong adhesive binding the expansion joint to the concrete.

In order to repair the voided area 48, epoxy is injected into the opening of the longitudinal through hole 18 in the head 12 of the fastener 10, which is accessible from the surface of the roadway. As the epoxy is injected, it flows through the fastener 10 via the through hole 18 and exits the fastener 10 through the opening of the through hole 18 on the bottom surface of the shank 14. As shown in FIG. 3, the bottom of the shank 14 is adjacent to the voided area 48. Thus, the epoxy flows out of the shank 14 of the fastener 10 and into the voided area 48 until the voided area is substantially filled with epoxy. Once the epoxy cures, the voided area 48 is repaired and the roadway can be re-opened to traffic.

Voided areas under expansion joints can vary significantly in size. FIG. 3 shows a relatively large voided area 48 as one example only for ease of illustration. In this example, because the voided area 48 is relatively large, the voided area 48 can be filled with epoxy at low pressure. In some instances, the voided areas may comprise relatively narrow cracks, which may extend in multiple directions within the concrete. In order to fill cracks that are relatively long and narrow, the epoxy may have to be injected into the voided areas under higher pressure than would be required to fill a relatively large voided area. The fastener 10 of the present invention may be configured to inject epoxy under high or low pressure, as needed, depending on the requirements of the particular application.

In a preferred embodiment, as shown in FIG. 1, the longitudinal through hole 18 has a section of female threads 20 positioned at the opening of the through hole 18 at the top of the head 12 of the fastener 10. Preferably, the remainder of the length of the through hole 18 has a generally smooth surface, which allows the epoxy to flow through the through hole 18 with less resistance. In alternative embodiments, the entire length of the through hole may have a generally smooth surface, or the entire length may be threaded.

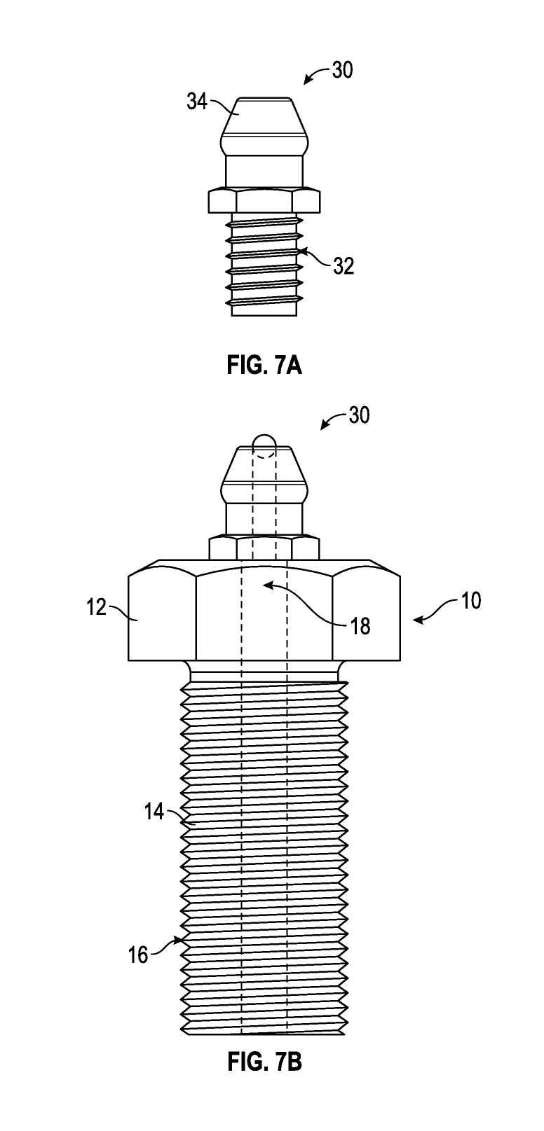

In applications requiring higher pressure to inject epoxy sufficient to effectively repair a relatively small or narrow voided area, a fitting 30 may be utilized with the fastener 10. FIG. 7A illustrates an exemplary fitting for high-pressure applications. The fitting 30 has male threads 32 at one end and a nipple 34 at the opposite end. The male threads 32 are compatible with the female threads 20 of the through hole 18 such that the fitting 30 may be threaded into the through hole 18 of the fastener 10, as illustrated in FIG. 7B. The nipple 34 is configured for injecting fluids into the through hole 18 under pressure greater than atmospheric pressure. The fitting 30 utilized may be any suitable commercially available fitting having male threads sized so as to be compatible with the female threads 20 in the through hole 18. Such fittings are commonly referred to as “grease fittings,” “grease nipples,” “Zerk fittings,” or “Alemite fittings.” Such fittings typically comprise a convex nipple 34 compatible with the concave outlet nozzle of a fluid injection gun, such as a standard grease gun, that is capable of forcing pressurized fluid into the nipple 34 of the fitting 30. The fitting 30 preferably comprises a bearing ball and a retaining spring located inside the fitting. When pressurized fluid is supplied, the bearing ball pushes against the force of the retaining spring and allows the pressurized fluid to pass through a passageway in the fitting 30 and into the through hole 18 in the fastener 10. When the pressure is removed, the ball returns to its original position in which fluid is not allowed to pass through the fitting. Thus, the fitting 30 functions as a check valve that allows flow in only one direction.

When a bridge expansion joint 40 is in need of repair, the fitting 30 is threaded into the through hole 18 in the fastener 10 in situ. Because the head 12 of the fastener 10 is accessible from the top of the finger plates 41, the fitting 30 is easily accessible from the surface of the roadway in which the expansion joint 40 is installed. A pressurized fluid injection gun is then connected to the exposed nipple 34 of the fitting 30. The gun is then used to supply pressurized epoxy or other flowable fill material into the nipple 30 and through the through hole 18 in the fastener 10, which extends through the finger plate 41 and the angle iron 42 of the expansion joint 40. The pressurized epoxy exits the shank 14 of the fastener 10 and is injected into the voided area 48 of concrete 46 below the expansion joint 40. The pressurized epoxy fills the voided areas 48 and is then allowed to cure in order to form an effective adhesive that binds the expansion joint 40 to the concrete 46 in which the joint is anchored. The fitting 30 can be removed from the fastener 10 once the repair is complete.

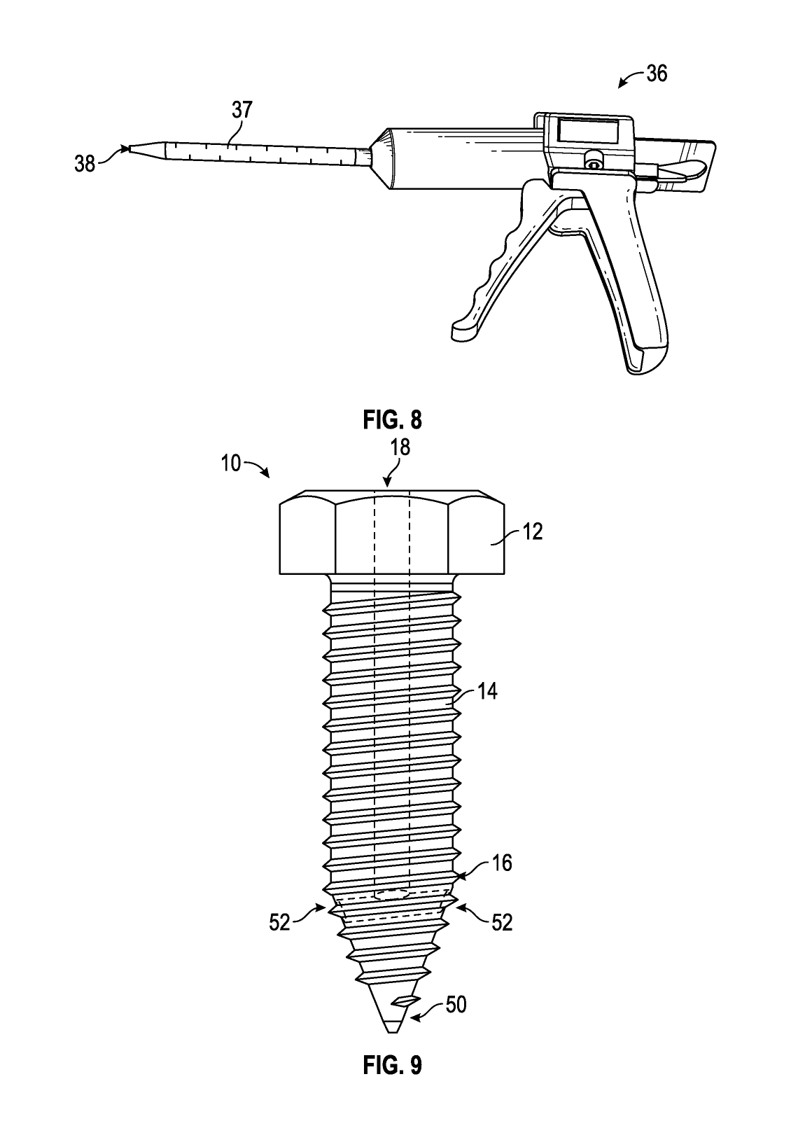

In applications that do not require high pressure to inject the epoxy into the voided area 48, a low-pressure fluid injection gun, such as a standard caulking gun, having an appropriately sized nozzle may be utilized to inject epoxy. FIG. 8 illustrates one example of a commercially available caulking gun 36 that may be used to inject epoxy in low-pressure applications. The gun 36 has a nozzle 37 connected to the outlet of the gun. The nozzle has a tip 38 sized such that the tip 38 can be inserted into the through hole 18 in the fastener 10 to inject epoxy into the through hole 18. Thus, in low pressure applications, the female threads 20 of the through hole 18 may not be utilized, though the fastener 10 preferably has female threads 20 so that the fastener 10 may be utilized in both high pressure and low pressure applications, depending on the requirements of a particular application.

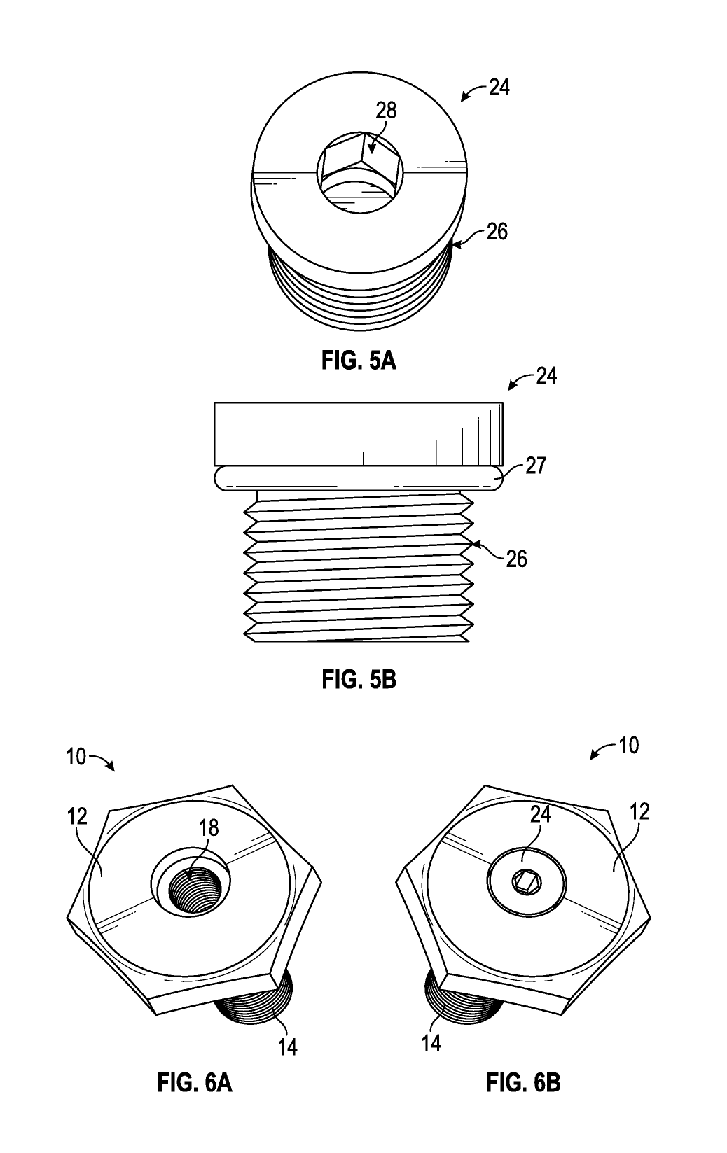

In a preferred embodiment, the fastener 10 further comprises a cap 24. FIGS. 5A and 5B show an exemplary embodiment of a cap that may be utilized with the present invention. In a preferred embodiment, the cap 24 has male threads 26 that are compatible with the female threads 20 of the through hole 18. Thus, the cap 24 can be threaded into the fastener 10 to cap the through hole 18 and then removed from the fastener 10 to inject epoxy for repairs. The cap 24 prevents dirt and other debris from getting into the through hole 18 and potentially blocking the through hole 18. If the through hole 18 were to become blocked, the blockage would have to be cleared before the through hole 18 could be used for fluid injection. The cap 24 is preferably pre-installed in newly manufactured fasteners or installed the first time that a fastener is used. The cap 24 preferably remains installed in fasteners until repairs are needed in order to avoid the added step of clearing a potential blockage of the through hole 18.

As shown in FIG. 5A, the cap 24 preferably has a hexagonal shaped socket 28 such that the cap 24 can be engaged with a standard hex key, also referred to as an Allen key or an Allen wrench, for threading the cap 24 into or out of the female threads 20 of the through hole 18. In alternative embodiments, the cap 24 may be configured for use with a screwdriver or any similar means for applying torque to the cap 24 for the purpose of installing or removing the cap 24 from the fastener 10. In addition, as shown in FIG. 5B, the cap 24 preferably has a rubber O-ring 27 around the male threads 26. The O-ring 27 helps to keep the top opening of the through hole 18 sealed, which helps to keep dirt and debris out the through hole 18.

FIG. 6A shows a fastener 10 without a cap 24, and FIG. 6B shows a fastener 10 with a cap 24 installed in the through hole 18. As shown in FIG. 6A, the head 12 of the fastener 10 preferably has a circular recess surrounding the top opening of the through hole 18. The recess is configured such that the cap 24 is flush with the head 12 of the fastener 10 when the cap 24 is installed in the through hole 18, as shown in FIG. 6B.

In an alternative embodiment, the cap may not have threads and is instead installed by inserting the cap into the through hole. For instance, the cap may be made of flexible plastic or rubber material configured to plug the through hole by inserting the cap directly into the through hole.

In one embodiment, the fastener 10 of the present invention is used for repairing voided areas 48 by fluid injection only once. A common problem with fasteners, such as bolts used in bridge expansion joints, is that they become loose over time. When epoxy is used to repair a voided area located under an installed bolt, the epoxy is used to fill the voided area up to the end of the shank 14 of the bolt, and the epoxy is then allowed to cure following the repair. Curing causes the epoxy to harden around the end of the shank 14 and the nut 22 used to hold the bolt in place, which prevents the bolt from becoming loose. The hardened epoxy may also seal the through hole 18 closed and prevent additional voids, thereby eliminating the need for future repairs in that location in the concrete.

Preferably, the fastener 10 of the present invention is used in new construction and is thus installed in newly installed bridge expansion joints. However, the fastener 10 may also be used to repair existing expansion joints 40. For existing expansion joints using bolts as fasteners, any bolt adjacent to the voided area to be repaired can simply be removed and replaced with a threaded fastener 10 having a longitudinal through hole 18 as described herein. The newly installed fastener 10 may then be used to repair the voided area 48 as described above.

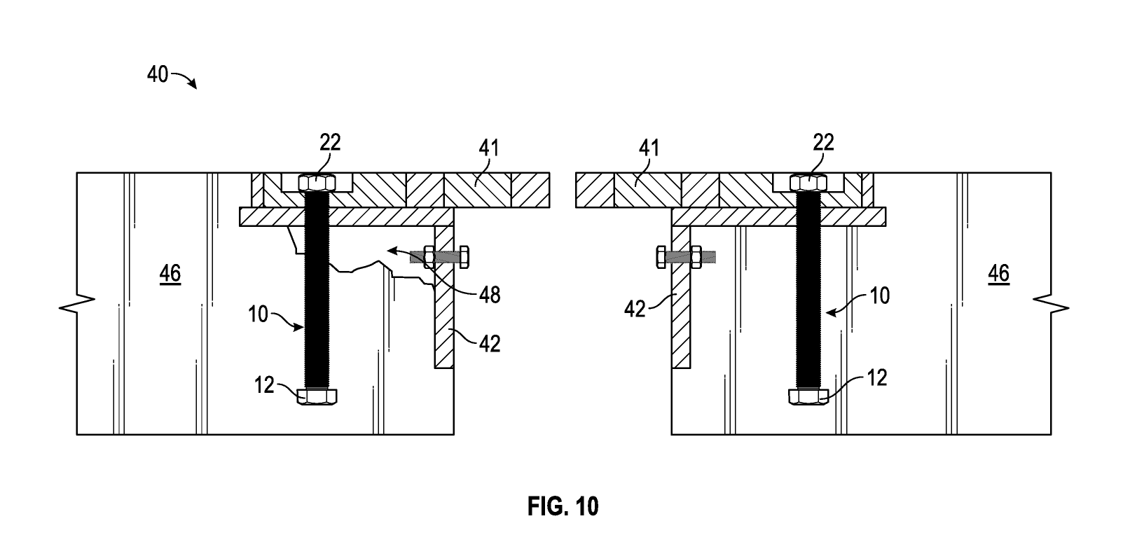

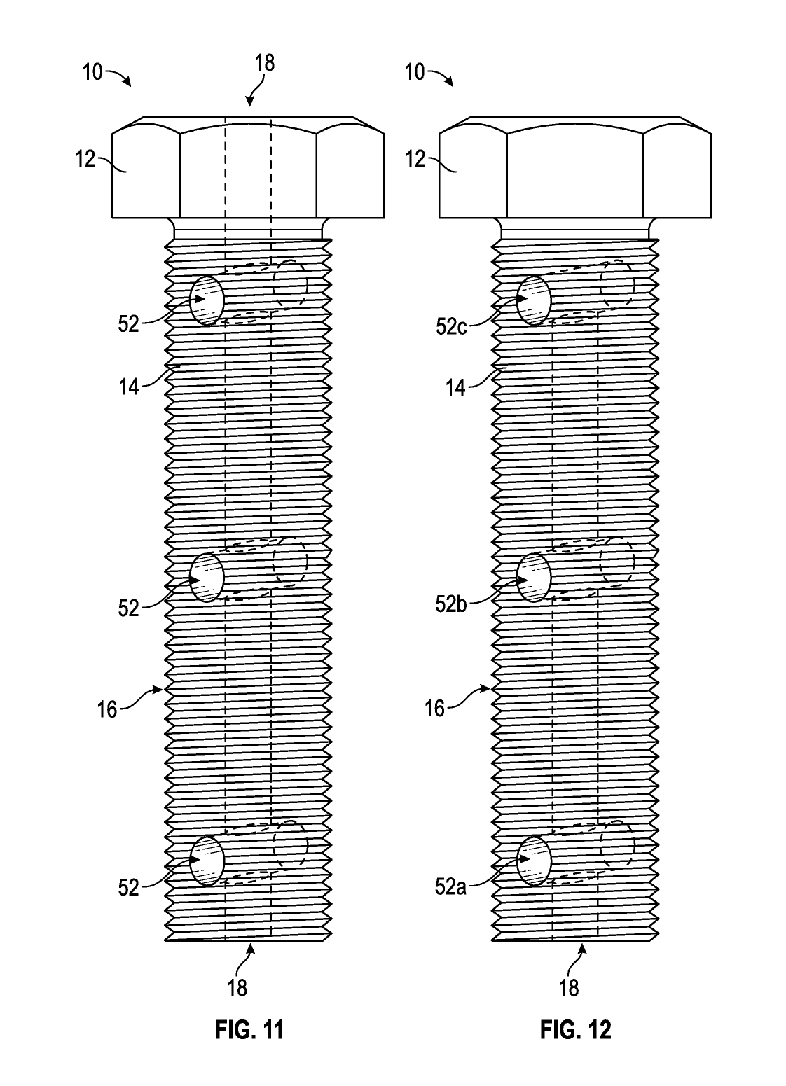

FIG. 10 shows a cross sectional view of an alternative type of bridge expansion joint 40. Unlike the joint 40 shown in FIG. 3, the joint 40 shown in FIG. 10 does not have anchor studs 44 attached to the angle iron 42 for anchoring the assembly in the concrete 46. Instead, in this type of expansion joint 40 the bolts 10 function as the anchor studs. In order to effectively anchor the assembly, bolts having longer shanks are utilized. Because of the longer shanks, the shank 14 of a bolt used in this type of assembly may pass through a voided area 48 in the concrete 46, as illustrated in FIG. 10. In this type of assembly, it may be advantageous to have one or more side exit points along the length of the shank 14 such that injected epoxy can flow out of the bolt and into the voided area 48 that the shank passes through. FIGS. 11-12 illustrate exemplary embodiments of a fastener 10 having a transverse through hole 52 providing a side exit point for the epoxy.

As shown in FIG. 11, the fastener 10 has a longitudinal through hole 18 and one or more transverse through holes 52. As an example only, FIG. 11 shows a bolt having three transverse through holes 52, though the number of transverse through holes may be varied depending on the application. The longitudinal through hole 18 extends through the head 12 and the shank 14 of the fastener 10, as previously discussed. The longitudinal through hole 18 preferably extends along the axis of rotation of the fastener 10. Each transverse through hole 52 extends through the shank 14 of the fastener. Each transverse through hole 52 preferably extends across the axis of rotation at the center of the shank 14 in a direction generally perpendicular to the axis of rotation. The longitudinal through hole 18 intersects each transverse through hole 52 inside the shank 14 to form a continuous passageway having side exit points in the shank 14 of the fastener 10.

The fastener 10 shown in FIG. 11 may be utilized in both high and low pressure applications, as previously discussed. The fastener 10 has a section of female threads positioned at the opening of the longitudinal through hole 18 at the top of the head 12 of the fastener 10 such that a grease fitting 30 can be installed for high pressure applications. As epoxy is injected into the head 12 through the top opening of the longitudinal through hole 18, the epoxy flows through the longitudinal through hole 18 and into each of the transverse through holes 52. If any of the side exit points of the transverse through holes 52 or the opening in the bottom of the shank 14 are adjacent to a voided area 48, epoxy flows into and fills the voided area 48 to make the repair.

FIG. 12 illustrates an alternative embodiment of a bolt having transverse through holes 52 in which the longitudinal through hole 18 does not extend through the entire length of the fastener 10 and is open at only one end. In the expansion joint 40 utilized in FIG. 10, the bolts 10 used as anchor studs may optionally be inverted such that the head 12 of the bolt 10 is anchored in the concrete 46. In this case, the opening at the bottom of the shank 14 is accessible from the roadway of the bridge. The fastener 10 shown in either FIG. 11 or FIG. 12 may be utilized in this application. In order to install a fitting 30 for high pressure applications, the fastener 10 has a section of female threads positioned at the opening of the longitudinal through hole 18 at the bottom of the shank 14. In a preferred embodiment, the fastener 10 has a section of female threads positioned at each opening located at each end of the longitudinal through hole 18 such that a fitting 30 can be installed at either end.

The fastener 10 illustrated in FIG. 12 comprises a head 12 at one end and a shank 14 at the opposite end, as in previously discussed embodiments. The fastener 10 has one or more transverse through holes 52 extending through the shank 14 and a longitudinal through hole 18 extending from one end of the fastener 10 and terminating at a distal transverse through hole 52c. Thus, the longitudinal through hole 18 and each of the transverse through holes 52 form a continuous passageway beginning at one end of the fastener 10 and extending through the longitudinal through hole 18 and each transverse through hole 52. In the embodiment shown in FIG. 12, the longitudinal through hole 18 begins at the bottom of the shank 14 and intersects two transverse through holes 52a, 52b before terminating at the distal transverse through hole 52c. In another alternative embodiment, the longitudinal through hole 18 may begin at the top of the head 12 and terminate at a distal transverse through hole located nearest the bottom of the shank 14. As used herein, the term “distal transverse through hole” refers to the transverse through hole located farthest from the open end of a longitudinal through hole in any embodiment having more than one transverse through hole and in which the longitudinal through hole is open at only one end.

Although the fastener 10 of the present invention is advantageous when used in repairing voided areas under expansion joints in concrete bridges, one skilled in the art should understand that the present invention may be used effectively in any application where injecting fluids through a fastener in situ is required. Thus, the present invention may be effectively utilized with any structures or objects fastened with bolts or screws which have loose or voided substructure elements. For instance, wooden bridges or other similar structures often have loose or voided substructure due to decay or insect damage. The fastener of the present invention may also be used to inject epoxy or other flowable fill material to repair such voided areas in wooden structures, among other applications.

FIG. 9 shows an alternative embodiment of the present invention wherein the fastener 10 is a screw. As in previously discussed embodiments, the screw has a head 12 and a shank 14. However, the shank 14 of the screw has a pointed distal end 50 opposite the head 12. The screw may be a standard wood screw, a lag screw, also referred to as a lag bolt, which may or may not be utilized with a nut, or any similar screw having a pointed end. The shank 14 may be partially threaded, or it may be fully threaded along its entire length. The head 12 preferably has a hexagonal outer surface such that the head of the screw can be engaged with a wrench. Alternatively, the head 12 may be configured for use with a screwdriver or any similar means for applying torque to the screw.

As shown in FIG. 9, the screw has a transverse through hole 52 and a longitudinal through hole 18. The transverse through hole 52 extends through the shank 14 of the fastener 10. The transverse through hole 52 preferably extends across the axis of rotation at the center of the shank 14 in a direction generally perpendicular to the axis of rotation. The longitudinal through hole 18 extends through the head 12 and a portion of the shank 18 from the head 12 to the transverse through hole 52. The longitudinal through hole 18 preferably extends along the axis of rotation of the fastener 10. The longitudinal through hole 18 terminates at the transverse through hole 52 to form a continuous passageway beginning at the head 12 of the fastener 10 and extending through the longitudinal through hole 18 and the transverse through hole 52.

The transverse through hole 52 is preferably positioned at a location substantially near the distal end 50 of the shank 14 such that the longitudinal through hole 18 extends through a substantial portion of the shank 14. As shown in FIG. 9, the transverse through hole 52 is preferably located at or near the area of the shank 14 where the shank 14 begins to taper to a point. This embodiment is preferred so that the epoxy or other fluid injected into the screw will exit the shank relatively close to the distal end 50 of the shank 14, which is the area of the shank 14 that is more likely to be adjacent to voided substructure areas in need of repair. However, it should be understood that the transverse through hole 52 may be located at any point along the length of the shank 14 and still fall within the scope of the present invention. Because the shank of a screw does not have a flat bottom surface as the shank of a bolt, the embodiment illustrated in FIG. 9 is preferred in applications utilizing screws or any similar fastener having a shank with a pointed end.

Alternatively, the screw may comprise more than one transverse through hole 52. In this case, the longitudinal through hole 18 intersects one or more transverse through holes and terminates at a distal through hole located nearest the distal end 50 of the screw.

The screw shown in FIG. 9 may be utilized in both high and low pressure applications, as previously discussed. In a preferred embodiment, the longitudinal through hole 18 in the screw has a section of female threads 20 positioned at the opening of the longitudinal through hole 18 at the top of the head 12 of the fastener 10, as illustrated in FIG. 1. Preferably, the remainder of the length of the longitudinal through hole 18 and the transverse through hole 52 has a generally smooth surface, which allows the epoxy to flow with less resistance. The fitting 30 shown in FIG. 7A is compatible with the screw shown in FIG. 9. Thus, if high pressure injection is needed, the fitting 30 is threaded into the longitudinal through hole 18 and used to inject epoxy into the longitudinal through hole 18. The epoxy flows through the longitudinal through hole 18 and into the transverse through hole 52. The flow of epoxy may then split in two directions and flow out of the shank 14 through openings on opposite sides of the shank 14.

Additionally, the cap 24 shown in FIGS. 5A and 5B is also compatible with the screw shown in FIG. 9. The cap 24 may be threaded into the longitudinal through hole 18 to cap the opening at the top of the head 12 of the fastener 10 to keep dirt and debris out of the through hole 18, as previously discussed.

It is understood that versions of the invention may come in different forms and embodiments. Additionally, it is understood that one of skill in the art would appreciate these various forms and embodiments as falling within the scope of the invention as disclosed herein.

What is claimed is:

1. A fastener comprising a head and a shank, said fastener having a longitudinal through hole extending through the head and the shank.

2. The fastener of claim 1, wherein the longitudinal through hole extends along the axis of rotation of the fastener.

3. The fastener of claim 1, said fastener having one or more transverse through holes extending through the shank of the fastener such that each transverse through hole intersects the longitudinal through hole.

4. The fastener of claim 3, wherein each transverse through hole extends across the axis of rotation in a direction generally perpendicular to the axis of rotation.

5. The fastener of claim 1, wherein the head has a polygonal shaped outer surface.

6. The fastener of claim 1, wherein the shank has male threads along at least a portion of the length of the shank.

7. The fastener of claim 1, wherein the longitudinal through hole has female threads along at least a portion of the length of the longitudinal through hole such that a threaded fitting can be threaded into the longitudinal through hole.

8. The fastener of claim 7, further comprising a fitting having two ends, the first end having male threads compatible with the female threads of the longitudinal through hole, the second end comprising a nipple configured for injecting fluids into the longitudinal through hole under pressure greater than atmospheric pressure.

9. The fastener of claim 1, further comprising a removable cap configured for capping the through hole.

10. A fastener comprising a head at one end and a shank at the opposite end, said fastener having one or more transverse through holes extending through the shank and a longitudinal through hole extending from one end of the fastener and terminating at a distal transverse through hole, wherein the longitudinal through hole and each of the transverse through holes form a continuous passageway.

11. The fastener of claim 10, wherein the longitudinal through hole extends along the axis of rotation of the fastener.

12. The fastener of claim 10, wherein each transverse through hole extends across the axis of rotation in a direction generally perpendicular to the axis of rotation.

13. The fastener of claim 10, wherein the head has a polygonal shaped outer surface.

14. The fastener of claim 10, wherein the shank has male threads along at least a portion of the length of the shank.

15. The fastener of claim 10, wherein the longitudinal through hole has female threads along at least a portion of the length of the longitudinal through hole such that a threaded fitting can be threaded into the longitudinal through hole.

16. The fastener of claim 15, further comprising a fitting having two ends, the first end having male threads compatible with the female threads of the longitudinal through hole, the second end comprising a nipple configured for injecting fluids into the longitudinal through hole under pressure greater than atmospheric pressure.

17. The fastener of claim 10, further comprising a removable cap configured for capping the longitudinal through hole.

18. A method of injecting fluids through a fastener, said method comprising the steps:
a. providing a fastener comprising a head and a shank, said fastener having a longitudinal through hole extending through the head and the shank;
b. using the fastener to fasten desired materials together; and
c. injecting a fluid into the longitudinal through hole in situ such that the fluid flows through the fastener.

19. The method of claim 18, wherein the longitudinal through hole has female threads along at least a portion of the length of the longitudinal through hole such that a threaded fitting can be threaded into the longitudinal through hole.

20. The method of claim 19, further comprising the step of attaching a fitting having male threads to the fastener by threading the male threads of the fitting into the female threads of the longitudinal through hole, said fitting configured for injecting a fluid into the longitudinal through hole.

21. The method of claim 20, wherein the step of injecting a fluid into the longitudinal through hole comprises the steps of attaching an injection gun outlet nozzle to the fitting and injecting the fluid through the fitting into the longitudinal through hole.
